(19) United States
(12) Patent Application Publication
(10) Pub. No.: US 2005/0267783 A1
(43) Pub. Date: Dec. 1, 2005

(54) Method and computerized system for reducing risk in an energy industry

(76) Inventors: Edward Zaccaria, Newtown, PA (US); David Hoog, Bala Cynwyd, PA (US); David Fromer, New York, NY (US); Mark Mayers, New York, NY (US); Dennis Kane, Island Heights, NJ (US); Kurt Husar, West Chester, PA (US); Gary Hawk, Monroe, GA (US); Paul O'Neill, Marietta, GA (US)

Correspondence Address: Edward F. Behm, Jr., 2500 One Liberty Place, 1650 Market Street, Philadelphia, PA, 19103, US

(21) Appl. No.: 11/153,912

(22) Filed: Jun. 15, 2005

Related U.S. Application Data
(63) Continuation of application No. 09/814,682, filed on Mar. 20, 2001.

(51) Int. Cl. H04B 1/69

(52) U.S. Cl. 705/4

(57) ABSTRACT

A method and computerized system for reducing risk actually assumed by at least one of a plurality of parties, wherein at least one of the parties supplies electric power to at least one other of the parties, and if an unplanned at least partial failure to supply the electric power occurs, at least one of the parties assumes the risk. The method includes designating at least one factor associated with the supplying of electric power and for determining whether an unplanned at least partial failure to supply the electric power that occurs is a qualifying event; designating a compensation which will at least partially reduce the risk actually assumed by the at least one of the parties assuming the risk if the unplanned at least partial failure to supply the electric power occurs and is determined to be a qualifying event; and, establishing a relationship between the at least one of the parties assuming the risk and at least one other party. The at least one other party agrees to provide the compensation to the at least one of the parties assuming the risk if the unplanned at least partial failure to supply the electric power occurs and is determined to be a qualifying event.

### RELATED APPLICATION

This application is a continuation of U.S. patent application Ser. No. 09/814,682, filed Mar. 20, 2001, entitled “METHOD AND COMPUTERIZED SYSTEM FOR REDUCING RISK IN AN ENERGY INDUSTRY”.

### FIELD OF THE INVENTION

The present invention relates to methods for reducing assumed risks in a restructured energy industry and computer-implemented systems for establishing relationships for reducing such risks.

### BACKGROUND OF THE INVENTION

In the restructured electric power market, electric power suppliers (e.g., power generators that do not sell some or all of their power directly to end-users or power re-marketers that do not resell some or all of their power) typically sell electric power to power purchasers pursuant to either “unit contingent” or “financially firm” power supply contracts. In the “unit contingent” contracts, the electric power supplier is typically not financially responsible to the purchaser if, for example, the equipment (e.g., generator(s) and/or transformer(s)) used for supplying power under the contract fail in whole or in part due to an unplanned event (e.g., an unplanned outage or derate of a unit). Thus, in the case of “unit contingent” contracts, the power purchaser typically must purchase replacement power in the open market at the time of the unplanned event. The cost of such power is unpredictable and extremely volatile. “Financially firm” power supply contacts are, in essence, the converse of “unit contingent” contracts. Such “financially firm” power supply contracts usually have liquidated damages provisions. Thus, in “financially firm” contracts, the electric power supplier is contractually obligated to deliver power to the purchaser and, thus, must purchase replacement power on the open market for the power purchaser in the case of an unplanned event that, for example, causes the equipment used for supplying power under the contract to fail in whole or in part. Thus, in “financially firm” contracts, the financial risks associated with purchasing replacement power are borne by the power supplier rather than by the power purchaser.

Both buyers and sellers of electric energy thus face significant financial risks in a restructured market. Such risks include power generation availability, transmission reliability, and financial performance of counter-parties or trading partners in a market in which prices are highly volatile. Volatility in energy prices results in higher budgets, reduced profitability and, ultimately, stock prices. Prior to the invention of the methods and systems defined herein, the only method for dealing with such risks were one-on-one counterparty deals and speculative financial instruments.

The present invention offers advantages over financial instruments and other prior art solutions. The present invention provides methods and systems of insuring risks with predictable pricing based on risk assessment, rather than market mechanisms; coverage for individual exposures; coverage for any amount, for any time period, and for particular risks identified by the insured, in short, complete flexibility in program design.

The present invention allows sellers of electric energy to market power to more customers and with greater confidence and allows buyers of electric energy to seek out alternative sources of power at different levels of firmness, obtain favorable terms and lock in savings.

As electric power restructuring progresses, power transactions are becoming a critical part of corporate business plans. Sellers with access to power must find new buyers. Buyers must achieve assured delivery at the lowest practical cost. Buyers must understand the force majeure/liquidated damage provisions in their contracts and realize that buying a fixed cost contract is not always the most effective solution to meeting their energy needs.

The methods and systems of the present invention combine custom tailored risk management solutions which are an innovative means of managing budgets, reducing costs and obtaining greater flexibility in the restructured electric power industry.

### SUMMARY OF THE INVENTION

A method and computerized system for reducing risk actually assumed by at least one of a plurality of parties, wherein at least one of the parties supplies electric power to at least one other of the parties, and if an unplanned at least partial failure to supply the electric power occurs, at least one of the parties assumes the risk, the method including: designating at least one factor associated with the supplying of electric power and for determining whether an unplanned at least partial failure to supply the electric power that occurs is a qualifying event; designating a compensation which will at least partially reduce the risk actually assumed by the at least one of the parties assuming the risk if the unplanned at least partial failure to supply the electric power occurs and is determined to be a qualifying event; and, establishing a relationship between the at least one of the parties assuming the risk and at least one other party, wherein the at least one other party agrees to provide the compensation to the at least one of the parties assuming the risk if the unplanned at least partial failure to supply the electric power occurs and is determined to be a qualifying event.

### BRIEF DESCRIPTION OF THE DRAWINGS

Other objects, features and advantages of the present invention will become more fully apparent from the following detailed description of the preferred embodiments, the appended claims and the accompanying drawing in which:

FIG. 1 is a diagram of the computer-implemented system for generating an insurance policy; and,

FIG. 2 is a diagram of the computer-implemented system for generating an insurance policy formed from a plurality of networked computers.

### DETAILED DESCRIPTION OF THE PREFERRED EMBODIMENTS

The entire disclosure of U.S. patent application Ser. No. 09/369,699, filed Aug. 6, 1999, entitled “METHODS FOR INSURING RISKS IN RESTRUCTURED ENERGY INDUSTRY AND COMPUTER-IMPLEMENTED SYSTEMS FOR ISSUING AN INSURANCE POLICY WHICH INSURES RISKS IN RESTRUCTURED ENERGY INDUSTRY” is hereby incorporated by reference herein.

The present invention is directed to a method for insuring against risks in an energy industry, wherein an electrical power purchaser has an underlying power supply contract with a contracting power supplier, and the contracting power supplier has no obligation to supply electrical power to the electrical power purchaser in the case of an unplanned event that prevents the contracting power supplier from meeting all or part of the supplier's power requirements under the power supply contract. The supplier's power requirements which the electrical power purchaser seeks to have covered are designated in an insurance policy. The insurance policy provides insurance coverage to the electrical power purchaser that protects the electrical power purchaser from financial losses (e.g., the volatility associated with replacement power costs) associated with the occurrence of an unplanned event. A coverage period in which the insurance policy will be in effect, an insured price for replacement or substitute power, and one or more unplanned events which give rise to a need for replacement or substitute power are also designated in the insurance policy. The designated unplanned events trigger an indemnification obligation under the insurance policy if a market price for replacement power exceeds the insured price. In the method of the present invention, the insurer receives a premium payment from the insured in consideration for the indemnification obligation of the insurer under the insurance policy during the coverage period. After issuance of the insurance policy by the insurer, the insurer is obligated to indemnify the electrical power purchaser from financial losses associated with the occurrence of an unplanned event, by reimbursing the insured for costs associated with the replacement power or by supplying substitute power to the insured, upon the triggering of an indemnification obligation which occurs during the coverage period.

The present invention is also directed to a method for insuring against risks in an energy industry, wherein a power supplier has an underlying power supply contract with a contracting electrical power purchaser, and the power supplier has an obligation to supply electrical power to the electrical power purchaser in the case of an unplanned event that prevents the power supplier from meeting all or part of the power supplier's obligations under the power supply contract. The supplier's power obligation which the power supplier seeks to have covered is designated in an insurance policy. The insurance policy provides insurance coverage to the power supplier that protects the power supplier from financial losses associated with the occurrence of an unplanned event. A coverage period in which the insurance policy will be in effect, an insured price for replacement or substitute power, and one or more unplanned events which give rise to a need for replacement or substitute power are also designated in the insurance policy. The designated unplanned events trigger an indemnification obligation under the insurance policy if a market price for replacement power exceeds the insured price. In the method of the present invention, the insurer receives a premium payment from the insured in consideration for the indemnification obligation of the insurer under the insurance policy during the coverage period. After issuance of the insurance policy by the insurer, the insurer is obligated to indemnify the power supplier from financial losses associated with the occurrence of an unplanned event, by reimbursing the insured for costs associated with the replacement power or by supplying substitute power to the insured, upon the triggering of an indemnification obligation which occurs during the coverage period.

The present invention is also directed to a computer-implemented system for generating an insurance policy for insuring against risks in an energy industry wherein an electrical power purchaser has an underlying power supply contract with a contracting power supplier, and the contracting power supplier has no obligation to supply electrical power to the electrical power purchaser in the case of an unplanned event that prevents the contracting power supplier from meeting all or part of the supplier's power requirements under the power supply contract. The invention includes a computer that accepts as its inputs at least the following factors: the supplier's power requirements which the electrical power purchaser seeks to have covered by an insurance policy, wherein the insurance policy provides insurance coverage to the electrical power purchaser that protects the electrical power purchaser from financial losses associated with the occurrence of an unplanned event; a coverage period in which the insurance policy will be in effect; an insured price for replacement or substitute power; and one or more unplanned events which give rise to a need for replacement or substitute power, and which trigger an indemnification obligation under the insurance policy if a market price for replacement power exceeds the insured price. The computer generates the policy in accordance with, at least, the factors set forth above. Under the insurance policy, the insurer is obligated to indemnify the insured by reimbursing the insured for costs associated with replacement power or supplying substitute power to the insured.

The present invention is also directed to a computer-implemented system for generating an insurance policy for insuring against risks in an energy industry wherein a power supplier has an underlying power supply contract with a contracting electrical power purchaser, and the power supplier has an obligation to supply electrical power to the electrical power purchaser in the case of an unplanned event that prevents the power supplier from meeting all or part of the power supplier's obligations under the power supply contract. The invention includes a computer that accepts as its inputs at least the following factors: the supplier's power obligation which the power supplier seeks to have covered by an insurance policy, wherein the insurance policy provides insurance coverage to the power supplier that protects the power supplier from financial losses associated with the occurrence of an unplanned event; a coverage period in which the insurance policy will be in effect; an insured price for replacement or substitute power; and one or more unplanned events which give rise to a need for replacement or substitute power, and which trigger an indemnification obligation under said insurance policy if a market price for replacement power exceeds the insured price. The computer generates the policy in accordance with, at least, the factors set forth above. Under the insurance policy, the insurer is obligated to indemnify the insured by reimbursing the insured for costs associated with replacement power or supplying substitute power to the insured.

In the preferred embodiment, the unplanned event insured under the policy may be a failure in power generation, a failure of power transmission, an intervention by a control area which directs that certain power be backed down or cut off, or a failure to perform by a counterparty to a contract. Such unplanned events may be associated with, for example, an unplanned derate and/or unplanned outage of power.

The indemnification obligation of the insurer preferably includes making substitute power available for the insured at an insured price at a point of power delivery or, alternatively, paying the insured for a replacement power loss. Pursuant to one aspect of the invention, if the unplanned event occurs during a time period which is not covered by the policy, the insurer has no indemnification obligation. Pursuant to other aspects of the invention, the insurer's indemnification obligation is limited by an outage/derate limit, by a dollar amount and/or by the amount of substitute power the insurer must supply or replacement power for which the insurer must pay.

A blank Exemplary Certificate of Insurance, which is included within this Detailed Description may accompany an insurance policy issued in accordance with the present invention. When an insured seeks to insure against risks in accordance with the methods and systems of the present invention through procurement of an insurance policy, the items identified on an insurance certificate such as the one appearing herein are designated. In particular, one or both parties designate, as applicable, the description of the transaction for which the insured seeks insurance (e.g., the underlying contract between the insured and another party for supplying power), the type of coverage desired (e.g., generation outage and derate protection), the retroactive effective date, the coverage effective date, the coverage expiration date, the identity and number of electrical power sources (i.e., the insured units) (e.g., particular generator(s) and/or transformer(s) used for supplying power under a power supply contract), the dependable capacity of each electrical power source, the unplanned event (i.e., the insured event), the insured quantity of electrical power, the outage/derate limit, the insured price for power, the market price for power, the insured hours, coinsurance, the aggregate capacity deductible for a system of insured units or the capacity deductible for each insured unit, the aggregate dollar deductible, the aggregate coverage period limit, the points of delivery, and any endorsements to the policy. One or more of the foregoing items may not be applicable and, thus, may not be designated in connection with a particular policy. Similarly, the insured may elect to designate certain of these factors, such as coinsurance, the capacity deductible or the aggregate capacity deductible, or the aggregate dollar deductible as zero.

The insurer considers the applicable factors, as well as any applicable physical characteristics of the designated electrical power sources, historical data, projections, and any applicable power market factors (e.g., estimated future costs of replacement power) which are obtained by the insurer through the insurer's investigation, and determines the premium amount. The insurer receives the premium payment from the insured and the policy is issued.

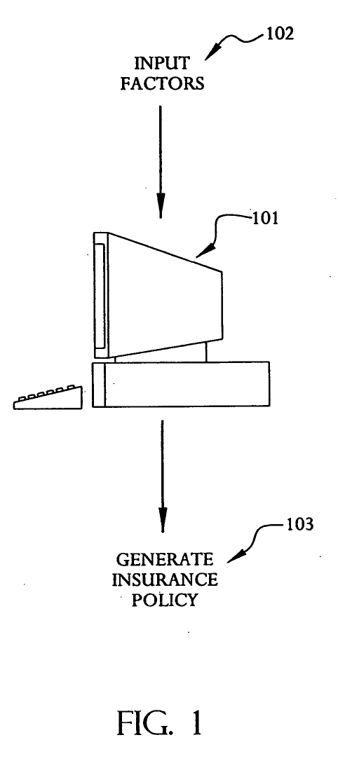

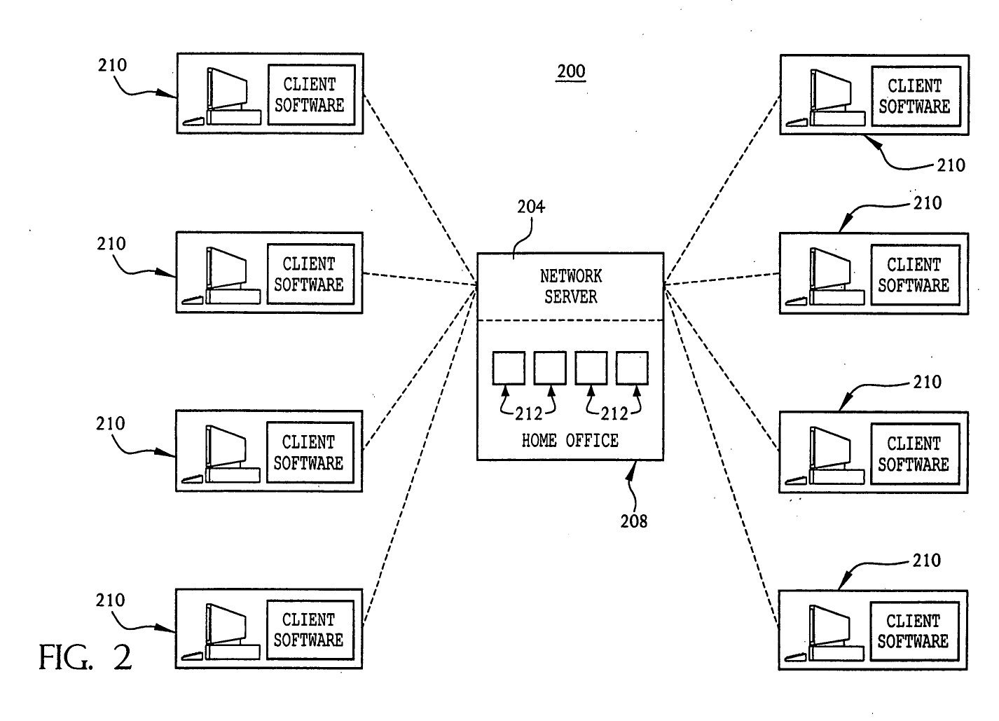

The policy may be generated in accordance with the present invention by a computer-implemented system which accepts as its inputs a variety of factors including those referred to above. FIG. 1 depicts the computer-implemented system of the present invention 100 wherein the computer 101 accepts a variety of factors as its inputs 102 and generates a policy 103 based on the factors. The computer-implemented system may also be formed from a plurality of networked computers 200 as shown in FIG. 2.

Referring to FIG. 2, there is shown a hardware block diagram of a system 200 for implementing the system 100 described above, in accordance with a preferred embodiment of the present invention. System 200 is preferably formed of a plurality of remote workstations 210, each of which includes client software for communicating with a network server 204 located at the home office 208 of the insurance company or its designee, that is issuing the subject insurance policies. A plurality of workstations 212 are included at the home office for auditing information submitted by insurance business producers through workstations 210. In an alternative embodiment, the workstations 210 may be those of an insured pursuant to which input factors used in connection with generating and issuing an insurance policy are inputted by the insured at the workstation 210 and communicated with the insurance company home office 208 via the network server 204.

An Exemplary Insurance Policy issued in accordance with the methods and systems of the present invention, along with a completed exemplary certificate of insurance is included within this Detailed Description. In this exemplary policy, the insured is covered against generation risks associated with unplanned outages and/or derates. Many of the terms used in this application are defined specifically in this Exemplary Insurance Policy. Those definitions represent exemplary definitions for such terms but it will be understood by those skilled in the art that the precise definitions used can vary from policy to policy and such variations are within the scope of the invention.

The insured under the policy can be any buyer of electrical power, such as a wholesale purchaser (e.g., a utility or power marketer), a retail purchaser or a load aggregator. The insured under the policy can also be any seller of electrical power, such as a power re-marketer, an electric cooperative, a load aggregator, a utility (e.g., a municipal utility or an investor-owned utility), an independent power producer, or an energy services company. Many of the foregoing entities may be either a seller or a buyer.

The underlying contract can be any contract which, upon the occurrence of an unplanned event, results in the need for the insured to purchase replacement power or receive substitute power, and where the market price for replacement power is volatile, the insured suffers a financial loss when it purchases the replacement power. For example, the underlying contract or obligation which forms the basis of the risk that the insured seeks to insure can be a power supply contract. The power supply contract can be a “unit contingent” power supply contract pursuant to which the power supplier is not obligated to supply power to the purchaser. In that case, the power purchaser will seek to insure against an unplanned event which gives rise to the need for the power purchaser to purchase replacement power or receive substitute power at a time when the market price for power is high. The power supply contract may also be a “financially firm” power supply contract pursuant to which the power supplier is obligated to supply power to the purchaser in a fixed quantity and/or at a fixed price. In that case, the power supplier will seek to insure against an unplanned event which gives rise to the need for the power purchaser to purchase replacement power or receive substitute power at a time when the market price for power is high. The contract may also be, for example, a “system firm” contract pursuant to which a utility, for example, may agree to sell power to another unless a particular event occurs (for example, a load increase or generation loss) and, if such event occurs, the utility may not supply power.

The unplanned event can be a failure in generation, in whole or in part (an availability risk); a failure in transmission, for example, a transmission curtailment resulting from unplanned intervention by a control area or a transmission interruption (a reliability risk); or a failure in counter-party performance, for example, a breach of contract, loss of financial capacity, bankruptcy, or third party breach of an interchange agreement (a performance risk); resulting in, for example, an unplanned outage and/or an unplanned derate, a need to purchase replacement power or to receive substitute power.

The market price may be calculated or determined in any manner agreed to by the parties including, for example, in accordance with a published index, which may or may not be adjusted. The market price for replacement power can also be, for example, the actual cost at which the insured, acting in a commercially reasonable manner and under a duty to mitigate losses, procures replacement power.

The coverage period of the policy can be any number of days. The policy provides coverage for the number of days in a week and the number of hours, or portions of hours, in each day designated. The designated hours can be on-peak hours, off-peak hours, or a combination of both on-peak and off-peak hours.

The insurer's indemnification obligation for a given unplanned event is determined in accordance with certain factors which may include, but need not be limited to, the market price for replacement power, the capacity deductible (which, for example, may be applicable to each electrical power source) or an aggregate capacity deductible (which, for example, may be applicable to an entire system of electrical power sources) and an amount of power loss associated with the unplanned event.

One or more electrical power sources to be covered by the policy may be designated. Also, the dependable capacity associated with each electrical power source may be designated. The dependable capacity can be determined, for example, in accordance with the capacity that the electrical power source can sustain over the coverage period and is calculated by modifying a maximum capacity of the electrical power source for any limitations on the maximum capacity of the electrical power source over a period of time. Other manners of calculating the dependable capacity are possible and within the scope of the invention.

In one embodiment, in order to satisfy the insurer's indemnification obligation, the insurer must either, at insurer's option, (1) make substitute power available for the insured to purchase at the insured price at one or more points of delivery designated or (2) pay the insured an amount equal to the replacement power loss. The replacement power loss amount is calculated by multiplying (A) the dollar amount by which the market price for replacement power exceeds the insured price times; (B) the insured quantity of electrical power, wherein the insured quantity of electrical power is calculated by subtracting 1) the aggregate capacity deductible from the total quantity of power associated with the unplanned event for all electrical power sources implicated by the unplanned event or 2) the capacity deductible from the total quantity of power associated with the unplanned event for each electrical power source implicated by the unplanned event; for each insured hour or portions of an insured hour implicated by the unplanned event. In an alternative embodiment, the indemnification obligation of the insurer consists of making substitute power available for the insured to purchase at the insured price. In a further embodiment, the insurer's indemnification obligation consists of paying the insured an amount equal to a replacement power loss.

There may be one or more limitations on the insurer's obligation to indemnify the insured when there is an unplanned event. For example, if replacement power is purchased at a market price which is at or below the insured price, the insurer has no indemnification obligation. Similarly, the insurer has no obligation to secure substitute power for the insured when the market price is less than the insured price. Also, the insurer's indemnity obligation may be limited by an aggregate coverage period limit designated, which is the insurer's maximum indemnity obligation in dollars. A coinsurance percentage may be designated, which is a percentage that is multiplied by the replacement power loss amount to determine a dollar amount of each replacement power loss that is excluded from the insurer's indemnity obligation. An aggregate dollar deductible may also be designated, which is an amount that the sum of all replacement power losses must exceed in the aggregate before the insurer is obligated to indemnify the insured for any additional replacement power loss or losses.

An outage/derate limit may also be designated which may also limit the insurer's indemnity obligation. The outage/derate limit is a period of consecutive calendar or business days or hours that each unplanned outage or unplanned derate of each electrical power source can contribute to the insured quantity. Where there is an unplanned outage, the beginning time of this period is the date or hour the electrical power source is electrically disconnected from the grid and the end time is the earlier of 1) the date or hour on which the electrical power source is in commercial operation or 2) the expiration of the outage limit. A ramp up period after an outage period can also be covered. Where there is an unplanned derate, the beginning time is the date or hour on which the unplanned derate begins and the end time is the earlier of 1) the date or hour on which the electrical power source is capable of achieving a generating level that is greater than the level it was generating at during the unplanned derate or 2) the expiration of the derate limit.

There may be one or more exclusions to coverage indicated in the policy, for example, those set forth in Sections 15 and 16 of the Exemplary Insurance Policy. One or more of these exclusions may be underwritten by the insurer, and, thus, not excluded from coverage.

Thus, protection against generation-related exposures in accordance with the present methods and systems, among other benefits, creates the capability on the part of the insured to buy or sell financially firm power from a single or multiple generation source; allows the insured to lock in savings or cost by eliminating wide swings in the price/cost of power; reduces financial uncertainty associated with unplanned unit outages or derates; reduces the basis risk connected with existing financial instruments; and allows the insured expand product offerings and trading limits.

Further, protection against transmission-related exposures, including those resulting from interventions by a control area, in accordance with the methods and systems of the present invention, among other benefits, increases the opportunity of the insured to contract with new sources of power; provides additional alternatives in power sources, transmission interfaces and delivery points; protects against the risk that a transaction may become uneconomic because of a curtailment or a constraint in the contract path; and expands the range of deal structures.

Finally, protection against performance risks of counterparties in accordance with the methods and systems of the present invention, among other benefits, increases the number of viable counterparties for insured power transactions; avoids the risk of dealing with unrated trading partners and the consequences of a counterparty's failure to perform; eliminates credit losses; eliminates the need for administrative expenses connected with screening trade partners, credit evaluations, letters of credit, security deposits, or guarantees; and establishes, in advance, the “cost of risk” and incorporates it into contract terms.

The following are illustrative examples of the methods and systems according to this invention. Although the examples utilize only selected factors, it should be understood that the following examples are illustrative and not limitative.

### EXAMPLE 1

The insured is a power supplier with a “financially firm” contract to provide power to a power purchaser at $100 per megawatt hour (MWh). The insured purchases coverage for generation outage and derate protection from a period of Jan. 1, 1998, through Dec. 31, 1998, seven days a week, 24 hours a day. The insured designates three electrical power sources, Units 1, 2, and 3, with dependable capacities of 100 MW, 150 MW, and 200 MW, respectively. The aggregate coverage period limit designated by the insured is $10 million in aggregate for the portfolio of all electrical power sources. The capacity deductible designated by the insured is 25 MW for each insured unit. The insured quantity designated by the insured is the hourly concurrent unplanned outages, which is determined by the dependable capacity less the deductible and the concurrent unplanned derates, which is determined by the derated capacity less the deductible, among the electrical power sources. The insured price designated by the insured is $100/MWh for the entire coverage period. The market price of power is designated by the insured to be determined in accordance with the actual price of replacement power. The insured also designates one or more points of delivery for any substitute power which may become necessary.

The insurer calculates the premium based upon the factors designated by the insured as well as other factors, including those involving the physical characteristics of Units 1, 2 and 3 historical data, projections and power market factors. The insurer receives the premium from the insured and issues the policy.

On Feb. 3, 1998, Unit 2 experiences a generation outage which is covered by the policy for 2 hours which results in the insured having to purchase replacement power in order to satisfy its obligations under the firm contract. The market price (the actual cost) of replacement power is $100/MWh. The insurer has no obligation under the policy because the market price of replacement power is equal to the insured price.

### EXAMPLE 2

The facts are the same as in Example 1 except that the insured designates the aggregate capacity deductible as 200 MW for the system of Units 1, 2, and 3, and the market price of replacement power is $150/MWh. The insured has no indemnification obligation because the total megawatt quantity of the unplanned event (an outage of Unit 2) is only 150 MW which is less than the aggregate deductible designated by the insured.

### EXAMPLE 3

The facts are the same as in Example 1 except that the actual cost of replacement power is $200/MWh. The insurer must either make substitute power available in an amount equal to the insured quantity as calculated below at the price of $100/MWh at the point of delivery or, alternatively and at the insurer's option, the insurer must pay the insured for a replacement power loss in the amount of $25,000 which is calculated by multiplying the market price of replacement power minus the insured price [$200/MWh−$100/MWh]; by the insured quantity, which is the total quantity of the unplanned power event minus the capacity deductible [150 MW−25 MW]; by the insured hours [2 hours].

### EXAMPLE 4

The facts are the same as in Example 1 except that the actual cost of replacement power is $9,000/MWh. Furthermore, Unit 3 also experiences an unplanned outage, which is covered by the policy, for a period of 8 hours. The actual price of replacement power is also $9,000/MWh during this 8 hour time period. The insurer must either make substitute power available in an amount equal to the insured quantity as calculated below at the price of $100/MWh at the point of delivery or, alternatively and at the insurer's option, the insurer must pay the insured for a replacement power loss. In this example, the replacement power loss is $14,685,000 which is calculated by multiplying the market price of replacement power minus the insured price [$9000/MWh−$100/MWh] for units 2 and 3; by the insured quantity, which is the total quantity of the unplanned power event minus the capacity deductible; by the insured hours ([150 MW−25 MW] times [2 hours] for Unit 2 and [200 MW−25 MW] times [8 hours] for Unit 3). This amount exceeds the aggregate coverage period limit. Thus, the insurer is only obligated to pay the insured $10 million, which is the insurer's aggregate coverage period limit.

### EXAMPLE 5

The facts are the same as in Example 4 except that instead of designating a capacity deductible for each electrical power source, the aggregate capacity deductible designated by the insured is 100 MW for all designated electrical power sources. Also, Unit 3 experiences an outage for the same 2 hours as does Unit 2, instead of 8 hours as in Example 3. The insurer must either make substitute power available in an amount equal to the insured quantity as calculated below at a price of $100/MWh at the point of delivery or, alternatively and at the insurer's option, the insurer must pay the insured for a replacement power loss in the amount of $4,450,000 which is calculated by multiplying the market price of replacement power minus the insured price [$9000/MWh−$100/MWh] for Units 2 and 3; by the insured quantity which is the total quantity of the unplanned power event [350 MW (i.e., 150 MW for Unit 2 and 200 MW for Unit 3)] minus the aggregate capacity deductible of [100 MW] which is equal to 250 MW; by the insured hours [2 hours].

### EXAMPLE 6

The insured is a power marketer with a “unit contingent” contract with a power supplier pursuant to which the power supplier supplies power to the power marketer. Under the “unit contingent” contract, the power supplier is not obligated to supply power to the power marketer in the event of an unplanned outage or derate. The power marketer is obligated to resell power under one or more contracts in a quantity of 100 MW at a rate of $100 MWh.

The insured purchases coverage for generation outage and derate protection from a period of Mar. 1, 1998, through Sep. 30, 1998, five days a week (Monday through Friday), 16 peak hours a day. The insured designates 10 electrical power sources, Units 1 through 10, which generate the power it purchases from the power supplier under the “unit contingent” contract, each having a dependable capacity of 100 MW. The aggregate coverage period limit designated by the insured is $15,000,000 in aggregate for the portfolio of all electrical power sources. The capacity deductible designated by the insured is 25 MW for each insured unit. The insured quantity designated by the insured is the hourly concurrent unplanned outages, which is determined by the dependable capacity less the deductible and the concurrent unplanned derates, which is determined by the derated capacity less the deductible, among the electrical power sources, but in no event shall the insured quantity exceed 50 MW. The insured price designated by the insured is $100/MWh for the entire coverage period. The market price for replacement power is designated by the insured to be that price as indicated by a particular power market index. The insured designates a point of delivery for substitute power.

The insurer calculates the premium based upon the factors designated by the insured as well as other factors, including those involving the physical characteristics of each of the 10 Units and power market factors. The insurer receives the premium from the insured and issues the policy.

On Apr. 6, 1998, Unit 1 experiences a generation derate, which is covered by the policy, of 50 MW for 1 hour which results in the insured having to purchase replacement power in order to satisfy its obligations to resell. According to the index designated by the insured, the market price of replacement power is $200/MWh.

The insurer must make substitute power available at the price of $100/MWh in an amount equal to the insured quantity as calculated below at the point of delivery or, alternatively and at the insurer's option, the insurer must pay the insured for a replacement power loss in the amount of $2,500 which is calculated by multiplying the market price of replacement power minus the insured price [$200/MWh−$100/MWh] by the insured quantity, which is the total quantity of the unplanned derate event minus the capacity deductible [50 MW−25 MW] by the insured hours [1 hour].

### EXAMPLE 7

The facts are the same as in Example 6 except that the derate occurs and ends on Apr. 5, 1998, a Sunday, which does not fall within the insured hours designated by the insured. The insurer has no indemnification obligation.

### EXAMPLE 8

The insured is a power marketer with a “unit contingent” contract with a power supplier pursuant to which the power supplier supplies power to the power marketer. Under the “unit contingent” contract, the power supplier is not obligated to supply power to the power marketer. The power marketer, however, is obligated to resell 100 MW of the power it purchases from the power supplier at a price of $100/MWh for a period of 1 week (the week of Apr. 13 through Apr. 17, 1998) to another. The power supplier is new in the industry and its financial stability is unknown. Thus, the insured seeks performance risk protection under an insurance policy for its one week contract.

The insured purchases coverage for the performance risks of the power supplier; from a period of Mar. 1, 1998, through Sep. 30, 1998, five days a week (Monday through Friday), 16 peak hours a day. The aggregate coverage period limit designated by the insured is $15,000,000 in aggregate. The capacity deductible designated by the insured is 25 MW. The insured quantity designated by the insured is the total megawatt quantity of the unplanned event, i.e., performance failure by the supplier less the deductible. The insured price designated by the insured is $100/MWh for the entire coverage period. The market price for replacement power is designated by the insured to be that price as indicated by a particular power market index. The insured designates a point of delivery for substitute power.

The insurer calculates the premium based upon the factors designated by the insured as well as other factors. The insurer receives the premium from the insured and issues the policy.

On Apr. 6, 1998, the power supplier files for bankruptcy and, thus, fails to supply power to the insured, which results in the insured having to secure other power in order to satisfy its obligations under the one-week contract. According to the index designated by the insured, the market price of replacement power is $200/MWh.

The insurer must make substitute power available in an amount equal to the insured quantity as calculated below at the price of $100/MWh at the point of delivery, or alternatively and at the insurer's option, the insurer must pay the insured for a replacement power loss in the amount of $600,000, which is calculated by multiplying the market price of replacement power minus the insured price [$200/MWh−$100/MWh]; by the insured quantity, which is the total quantity of the unplanned power event minus the capacity deductible [100 MW−25 MW]; by the insured hours [80 hours].

### EXAMPLE 9

The insured is a power supplier with a contract to provide 100 MW of power to a power purchaser in Area C for $100/MWh. The insured purchases coverage which includes protection from intervention by a control area, from a period of Jan. 1, 1998 through Dec. 31, 1998, seven days a week, 24 hours a day. The insured designates one electrical power source which generates the power it uses to supply the purchaser in Area C, Unit 1, which has a dependable capacity of 100 MW. The aggregate coverage period limit designated by the insured is $10 million. The capacity deductible designated by the insured is 50 MW for the insured unit. The insured quantity designated by the insured is the total megawatt quantity of the unplanned event, i.e., intervention by the control area, less the capacity deductible, but in no event shall the insured quantity exceed 100 MW. The insured price designated by the insured is $100/MWh for the entire coverage period. The market price for replacement power is designated by the insured to be the actual price of replacement power. The insured designates a point of delivery for substitute power.

The insurer calculates the premium based upon, among others, the factors designated by the insured. The insurer receives the premium from the insured and issues the policy.

On Feb. 3, 1998, the control area instructs the generator that it can not supply power to Area C for a period of 2 hours. This results in the insured having to purchase power in order to satisfy its obligations under its contract with the purchaser in Area C. The market price (the actual cost) of replacement power is $200/MWh. The insurer must make substitute power available in an amount equal to the insured quantity as calculated below at the price of $100/MWh at the point of delivery or, alternatively and at the insurer's option, the insurer must pay the insured for a replacement power loss in the amount of $10,000 which is calculated by multiplying the market price of replacement power minus the insured price [$200/MWh−$100/MWh]; by the insured quantity, which is the total quantity of the unplanned event minus the capacity deductible [100 MW−50 MW]; by the insured hours [2 hours].

### EXAMPLE 10

The facts are the same as in Example 9 except that the control area instructs the generator that it must back down the power into area C by an amount of 45 MW. Because the insured has designated the capacity deductible to be 50 MW and the total megawatt quantity of the unplanned event (45 MW) has not exceeded the capacity deductible, the insurer has no indemnification obligation.

[image]

[image]

[image]

[image]

[image]

[image]

[image]

[image]

[image]

[image]

[image]

[image]

[image]

[image]

[image]

[image]

[image]

It will be understood by persons skilled in the art that various changes in the factors, details, components, steps, and arrangements of the components and steps which have been described and illustrated in order to explain the nature of this invention may be made by those skilled in the art without departing from the principle and scope of the invention as expressed in the following claims.

1. A method for reducing risk actually assumed by at least one of a plurality of parties, wherein at least one of said parties supplies electric power to at least one other of said parties, and if an unplanned at least partial failure to supply said electric power occurs, at least one of said parties assumes said risk, said method comprising:
designating at least one factor associated with said supplying of electric power and for determining whether an unplanned at least partial failure to supply said electric power that occurs is a qualifying event;
designating a compensation which will at least partially reduce said risk actually assumed by said at least one of said parties assuming said risk if said unplanned at least partial failure to supply said electric power occurs and is determined to be a qualifying event; and,
establishing a relationship between said at least one of said parties assuming said risk and at least one other party, wherein said at least one other party agrees to provide said compensation to said at least one of said parties assuming said risk if said unplanned at least partial failure to supply said electric power occurs and is determined to be a qualifying event.

2. The method of claim 1, wherein said risk is an at least financial risk.

3. The method of claim 2, wherein said compensation comprises supplying substitute power.

4. The method of claim 2, wherein said compensation comprises financial compensation.

5. The method of claim 4, wherein said financial compensation is at least partially dependent upon a market price for replacement power.

6. The method of claim 5, wherein said financial compensation is further at least partially dependent upon a price for power supplied between said plurality of parties.

7. The method of claim 1, wherein said established relationship between said at least one of said parties assuming said risk and said at least one other party caps said compensation provided by said other party.

8. The method of claim 1, wherein said at least one factor comprises a power capacity.

9. The method of claim 9, wherein said at least one factor further comprises a power capacity deductible.

10. The method of claim 9, wherein said power capacity deductible is an aggregate capacity deductible.

11. The method of claim 1, wherein said at least one factor comprises at least one factor selected from the group consisting of: designating particular electric power generation or transmission equipment, designating one or more points of delivery, designating a coinsurance percentage of said risk, one or more counter-party performances, a price of power, a type of failure to supply said electric power, a deductible, and one or more periods of time.

12. The method of claim 1, wherein said establishing said relationship between said at least one of said parties assuming said risk and said at least one other party comprises said other party establishing an obligation to said at least one of said parties assuming said risk.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. The method of claim 1, wherein said establishing said relationship between said at least one of said parties assuming said risk and said at least one other party comprises establishing an insurance policy.

25. (canceled)

26. A computer-readable medium comprising computer-executable instructions for preparing a contingent benefit conferring obligation for reducing an actual risk assumed by a risk assuming at least one of a plurality of parties, wherein at least one of said parties supplies electric power to at least one other of said parties, and if an unplanned at least partial failure to supply said electric power occurs, said risk assuming at least one of said parties actually assumes said risk, said computer-executable instructions comprising:
instructions for designating data indicative of at least one factor associated with said supplying of electric power and for identifying if an unplanned at least partial failure to supply said electric power which occurs is a qualifying failure;
instructions for designating data indicative of a compensation which will at least partially reduce said assumed risk if an unplanned at least partial failure to supply said electric power occurs and is determined to be a qualifying failure; and,
instructions for generating at least one document associated with said contingent benefit conferring obligation at least partially dependently upon said designated data indicative of at least one factor and said designated data indicative of said compensation;
wherein, said benefit conferring obligation is between said risk assuming at least one of said parties and at least one other party, and wherein said at least one other party agrees to provide said compensation to said risk assuming at least one of said parties if an unplanned at least partial failure to supply said electric power occurs and is determined to be a qualifying failure.

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)
